(19) United States
(12) Patent Application Publication
(10) Pub. No.: US 2009/0167493 A1
(43) Pub. Date: Jul. 2, 2009

(54) VIDEO MONITORING SYSTEM

(76) Inventor: Fabrizio COLCIAGO, Milan (IT)

Correspondence Address: EATON PEABODY PATENT GROUP, LLC, P.O. BOX 5249, 77 Sewall Street, Suite 3000, AUGUSTA, ME, 04332-5249, US

(21) Appl. No.: 12/347,059

(22) Filed: Dec. 31, 2008

(30) Foreign Application Priority Data
Dec. 31, 2007 (EP) 07425851.8

(51) Int. Cl. G06F 7/04; H04N 7/18

(52) U.S. Cl. 340/5.83; 348/143; 348/E05.022

(57) ABSTRACT

A video monitoring system is described, comprising at least one video camera disposed in such a way as to capture an entrance area to the premises to be video monitored, an automatic door controlled by an actuator to regulate the access to the premises to be video monitored and a control system connected to the video camera and to the actuator, said control system comprising recognition means to recognise a face from the images captured by said video camera and accordingly to command said actuator for opening the door.

### FIELD OF TECHNOLOGY

The present invention relates to a video surveillance system, for monitoring access to video monitored premises, particularly banks and the like.

### BACKGROUND

As is known, banks are generally provided with video monitoring systems, which include one, or more video cameras adapted to film the people who enter the room to be monitored. The object of these video monitoring systems is to discourage possible robbers who could be recognised from the images captured by the video cameras. However, robbers are well aware of the presence of the video monitoring systems and tend not to face towards the video cameras so as not to be recognised.

In order to solve this problem at least in part, some banks, in combination with the known video monitoring systems, also use biometric data checking systems (such as, for example, fingerprint checking systems), which allow clients to access the bank's premises. In this manner, once the biometric system has taken the client's fingerprints, the video cameras capture his face and the door for access to the bank's premises is opened. Consequently, if the robber's face is not captured, he can be identified by his fingerprints. However, such a type of system with recording of biometric data does not comply with current regulations on privacy, since it records the clients' personal data.

An object of the present invention is to overcome the drawbacks of the prior art by providing a video monitoring system, in particular for banks, which is efficient, effective, versatile, practical and simple to produce.

### SUMMARY

The video monitoring system according to the invention comprises: at least one video camera disposed so as to frame an entrance area to a room to be video monitored, an automatic door controlled by an actuator to control the access to the room to be video monitored, and a control system connected to said video camera and to said actuator.

The control system comprises recognition means to recognise a face from the images captured by said video camera and accordingly to control said actuator for opening the door, so as to allow the access to the user whose face has been recognised.

The advantages of the video monitoring system according to the invention are obvious. In fact, the clients who must access the room are not asked to provide biometric data but simply to look towards the video cameras, which in any case are present inside the institute.

The system according to the invention allows the attitude of the individual in the entrance area to be evaluated. Anyone entering the bank with the intention of carrying out a robbery typically turns his or her gaze away from the video cameras or tries to hide his or her facial features. These behaviours lead the system not to identify the individual's face clearly enough and as a result not to open the door to prevent access by the suspect individual.

When a face is not identified, the system advantageously alerts the operators. However, the system according to the invention does not involve an excessive human intervention because it will be sufficient for the operators to order opening of the door if it is evident that the person in the entrance area is not suspicious-looking (but has perhaps not understood that the video camera has to film his or her face).

### BRIEF DESCRIPTION OF THE DRAWINGS

Further characteristics of the invention will be made clearer by the detailed description that follows, referring to a purely exemplifying and therefore non limiting embodiment thereof, illustrated in the appended drawings, wherein:

FIG. 1 is a block diagram showing diagrammatically the video monitoring system according to the invention;

FIG. 2 is a flow chart illustrating diagrammatically the operation of the video monitoring system according to the invention; and

FIG. 3 is a block diagram illustrating diagrammatically the operation of an algorithm for identifying faces used in the present invention.

### DETAILED DESCRIPTION

The video monitoring system according to the invention, designated as a whole with reference numeral 1, is described with the aid of the figures.

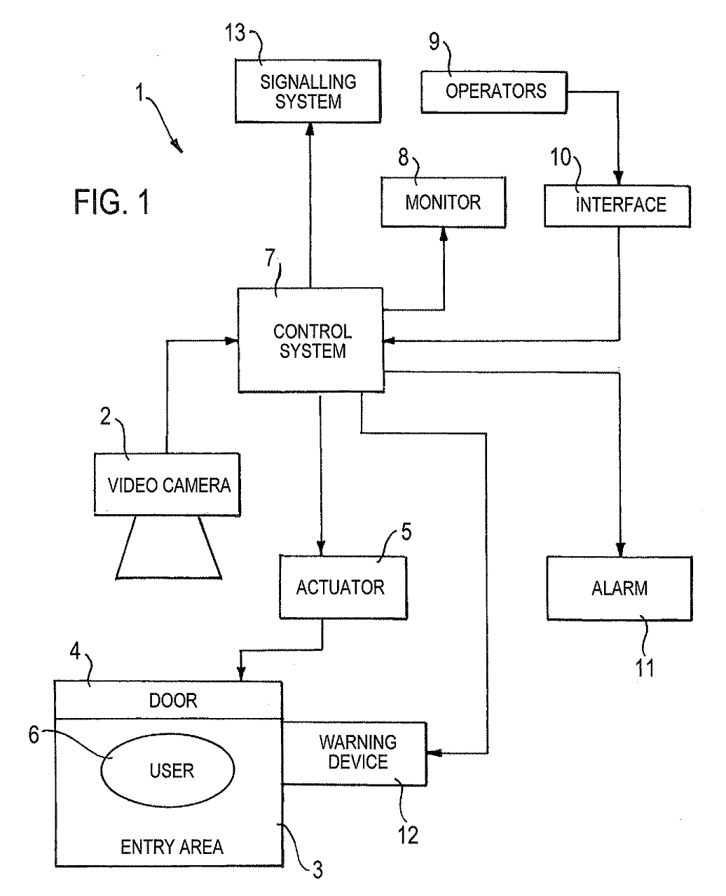

With reference to FIG. 1, the video monitoring system 1 comprises a video camera 2 or a group of video cameras directed towards an entrance area 3 disposed in front of an automatic door 4 which controls the access to a room to be video monitored, such as for example a room of a bank. As is known, the automatic door 4 is connected to an actuator 5 which opens/closes the door 4 according to special command signals sent to the actuator 5. The video camera 2 is positioned so as to be able to film the face of a user 6 who stands in the entrance area 3, waiting for the automatic door 4 to open to allow him access.

According to an embodiment, the video camera 2 is connected to a control system 7. The control system 7 can advantageously be integrated into the video camera 2. However, the control system 7 can also be implemented through any processor outside the video camera 2. The control system 7 comprises a processor wherein suitable software, which implements a face recognition algorithm, is installed, as will be described hereunder in greater detail. The control system 7 is operatively connected to the actuator 5 to control the opening of the automatic door 4. Furthermore, the control system 7 is connected to a warning device 12, such as for example a display and/or a loudspeaker adapted to signal video/audio warning messages to the user 6 who is in the entrance area 3. The control system 7 is operatively connected to a signalling device 13, to a video or monitor 8 and to an interface 10. The signalling device 13, the monitor 8 and the interface 10 can all be accessed by operators 9 who work inside the premises to be monitored or in a remote workstation. Lastly, the control system 7 is operatively connected to an alarm 11 adapted to be detected by a guard or by other security personnel authorised to intervene in the video monitored premises.

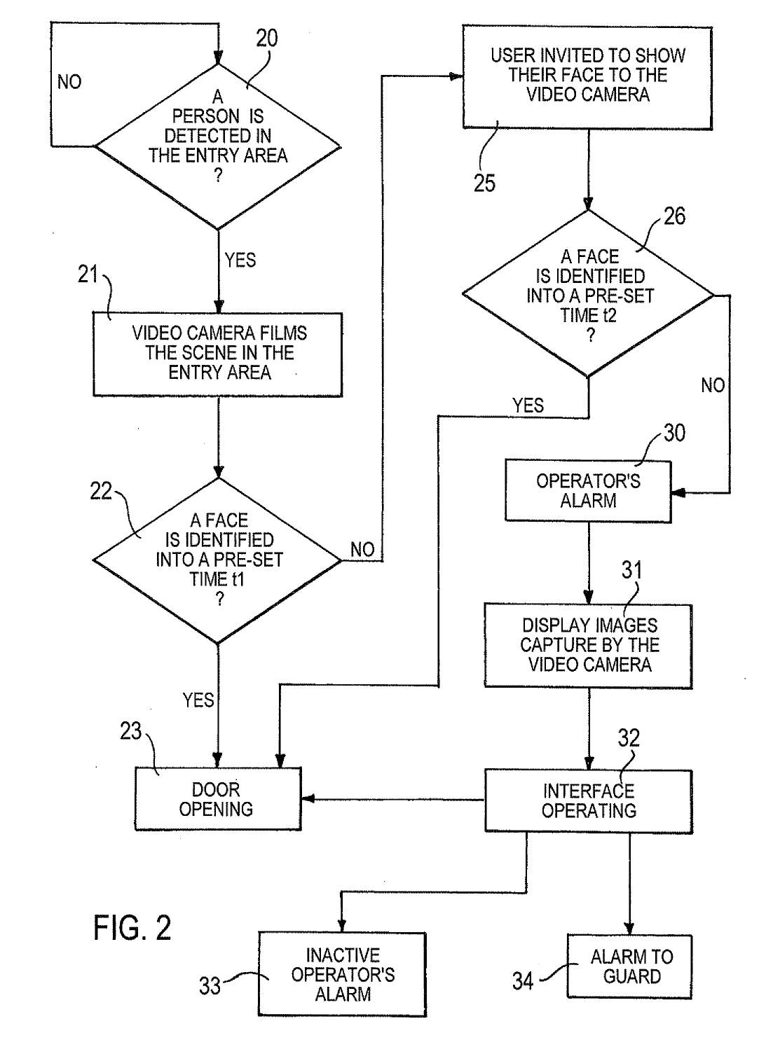

The operation of the video monitoring system 1 according to the invention is described with reference to FIG. 2. In the initial step 20, the presence of a person 6 who is in the entrance area 3 and wishes to enter the video monitored premises is detected. The presence of a person 6 can be detected by the video camera 2 itself or with presence detection sensors, per se known and therefore not illustrated. Obviously, when there is no-one in the entrance area 3 or when a person is leaving the entrance area 3, the video monitoring system is not activated.

Once the presence of a user 6 has been detected in the entrance area 3, the system proceeds to step 21, in which the video camera 2 films the scene in the entrance area 3. The images captured by the video camera are sent to the control system 7.

In step 22 the control system 7 establishes whether there is a face that can be identified clearly enough in the images captured by the video camera 2. If within a set time (t1) the control system 7 considers that in the images captured by the video camera there is a face that can be identified sufficiently clearly, the control system 7 sends a command signal to the actuator 5. In the next step 23, in accordance with the signal received from the control system 7, the actuator 5 opens the automatic door 4 to allow the user 6 to enter.

If, in the pre-set period of time (t1) the control system 7 fails to identify a recognisable face in the images captured by the video camera 2, the system proceeds to step 25, in which it prevents the opening of the door 4 and invites the user 6 to show his or her face to the video camera, through video and/or audio messages transmitted by the warning device 12, repeated once or a number of times at regular intervals.

At this point, the system proceeds to step 26 in which the control system 7 continues to attempt to identify a face from the images captured by the video camera 2. If within a pre-set interval of time (t2) a face is identified, the system proceeds with the door-opening procedure 23 by sending a command signal to the actuator 5 which controls the opening of the door 4.

If in the pre-set period of time (t2) the control system 7 fails to identify a recognisable face in the images captured by the video camera 2, the system proceeds to step 30, in which the control system 7 sends a warning signal to the operators 9, triggering the signalling device 13 which alerts the operators by means of an alarm signal.

In step 31 the control system 7 sends the images captured by the video camera 2 to the display 8 so that the operators 9 can see the scene in the entrance area 3 and possibly the person 6 who wants to access the video monitored premises, to be able to evaluate whether the person 6 has a suspicious demeanour.

Next, in step 32 the operator will be able to operate the interface 10 to send commands to the control system 7. The interface 10 advantageously comprises three keys designated for specific functions.

If there is no-one in the entrance area 3, the operator 9 operates a first key of the interface 10 to start a procedure 33 to inactivate the operators' alarm state.

If there is someone in the entrance area 3 who is not considered a suspicious individual, the operator 9, besides inactivating the operators' alarm, operates a second key of the interface 10 to order to activate the door-opening procedure 23 and to allow the person to enter.

If, on the other hand, there is a person in the entrance area 3 who is considered a suspicious individual, the operator 9 operates a third key of the interface 10 to start a procedure 34 for signalling the alarm to a guard. In this procedure 34 the alarm 11 is triggered and the door 4 is not opened to prevent the suspicious individual from entering. Consequently a guard is alerted and can proceed with possible identification of the suspicious individual.

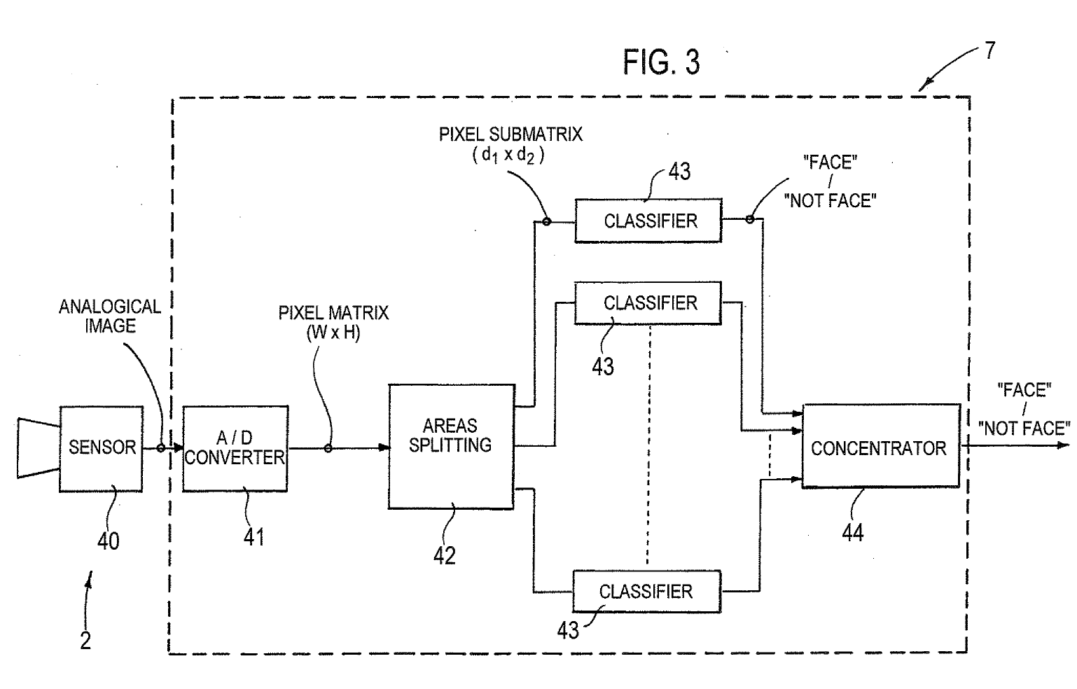

With particular reference to FIG. 3, purely by way of a non-limiting example, a face recognition algorithm implemented in the control system 7 that, as stated previously, can be integrated into the video camera 2 is illustrated below.

The video camera 2 acquires the scene in the entrance area continuously, by means of a group of sensors 40 which generate frames in the form of analogical images. The individual frames captured by the video camera 2 are digitalised by means of an analogical-to-digital converter 41, so that each frame is represented by a (W×H) pixel matrix.

The (W×H) pixel matrix forming each frame is split into a plurality of rectangular areas, partially overlapping and of different sizes, by means of special splitting software 42. These areas are represented by (d₁×d₂) pixel submatrixes.

A classifying software 43, which identifies the area as “FACE” or as “NOT FACE”, is applied to each (d₁×d₂) pixel submatrix.

The classifier 43 analyses each area of the image, verifying whether there are groups of pixels within them whose brightness and/or colour value could indicate the presence of a face. The region is classified as “FACE” only if the number of groups of pixels identified is sufficient.

The results of the classifiers 43 are sent to a concentrator 44, which decides that a face is present in the image if at least one of the classifiers has given a positive result.

For example the output of each classifier 43 is “1” if it identifies a face and “0” if it does not identify a face. In this case the concentrator 44 can be realised with an OR logic circuit whose output is “1” if at least one of its inputs is “1”.

The classification software 43 is realised starting from a digital images database containing examples of faces and examples of not-faces. The individual images can therefore contain the face of different persons photographed from the front, or photographs of natural scenes that do not contain people.

The position of the faces inside the individual images must be catologued manually and entered into the database. The database is used during the software design steps to identify automatically similar areas of pixels, which are repeated in the same positions and only in images containing faces. During this step the examples provided by the database are examined to identify the groups of pixels whose brightness and/or colour value is distinctly different for the “face” set and for the “not-face” set. The position of these groups of pixels inside the sample images will be used later by the algorithm to classify the content of the frames extracted by the video camera 2 on the scene.

Numerous changes and modifications of detail within the reach of a person skilled in the art can be made to the present embodiment of the invention without thereby departing from the scope of the invention as set forth by the appended claims.

We claim:

1. A video monitoring system comprising:
at least one video camera disposed so as to capture an entrance area of premises to be video monitored, and
an automatic door controlled by an actuator to regulate the access to the premises to be video monitored,
characterised in that it further comprises
a control system connected to said video camera and to said actuator, said control system comprising recognition means to recognise a face from the images captured by said video camera and accordingly to control said actuator for opening the door.

2. The system according to claim 1, further comprising a warning device connected to said control system to warn a user who is in the entrance area to turn his or her face towards the video camera, when the recognition means of the control system do not recognise the user's face after a pre-set period of time.

3. The system according to claim 1, further comprising a signalling device connected to said control system to signal an alarm to operators when the recognition means of the control system do not recognise a face after a pre-set period of time.

4. The system according to claim 3, further comprising a display or monitor connected to said control system and accessible to said operators to display the scene in the entrance area after said signalling device has signalled the alarm to said operators.

5. The system according to claim 3, further comprising an interface connected to said control system and accessible to said operators to disable said signalling device.

6. The system according to claim 3, further comprising an interface connected to said control system and accessible to said operators to control said actuator to open the door.

7. The system according to claim 5, further comprising an alarm device connected to said control system that can be operated by the operators by means of said interface to signal an alarm to a guard who can intervene for the recognition of the person in the entrance area.

8. The system according to claim 6, further comprising an alarm device connected to said control system that can be operated by the operators by means of said interface to signal an alarm to a guard who can intervene for the recognition of the person in the entrance area.

9. A video monitoring method to control the access to a video monitored room, the method comprising the following steps:
capturing by means of a video camera of the scene in an entrance area in which there is an automatic door for the access to video monitored premises, when a user is in said entrance area,
recognition of a face from the images captured by said video camera, and
opening of said door in accordance with recognition of the face.

10. The method according to claim 7, further comprising warning the user to turn his or her face towards the video camera, when his or her face is not recognised after a pre-set period of time.

11. The method according to claim 7, further comprising signalling an alarm to operators when the face of the user who is in the entrance area is not recognised after a pre-set period of time.

12. The method according to claim 11, wherein, after the signalling of the alarm to said operators, the scene in the entrance area is displayed.

13. The method according to claim 12, wherein said operators order the opening of said door if the viewing of the scene in the entrance area does not reveal risk situations.

14. The method according to claim 12, wherein said operators disarm the alarm state if the viewing of the scene in the entrance area does not reveal risk situations.

15. The method according to claim 12, wherein said operators send an alarm to a guard if the viewing of the scene in the entrance area reveals risk situations.
